(19) United States
(12) Patent Application Publication
(10) Pub. No.: US 2010/0031365 A1
(43) Pub. Date: Feb. 4, 2010

(54) Method and apparatus for providing network access privacy

(76) Inventors: Balachander Krishnamurthy, New York, NY (US); David Belanger, Hillsborough, NJ (US); Craig Wills, Acton, MA (US)

Correspondence Address: AT & T Legal Department - WS;Attn: Patent Docketing, Room 2A-207, One AT & T Way, Bedminster, NJ, 07921, US

(21) Appl. No.: 12/221,176

(22) Filed: Jul. 31, 2008

(51) Int. Cl. G06F 21/00

(52) U.S. Cl. 726/26

(57) ABSTRACT

A method for providing network access privacy by classifying filter parameters of a group of users who are accessing one or more network destinations. The system includes a means for collecting information from both users, and about network destinations, generating suggestions for a user regarding filter parameters, and filtering network communications of users going to network destinations. In operation, users who are accessing network destinations are prompted to choose from a selection of filter parameters. The information provided by these users is then analyzed and used to generate suggested filter parameters for other users. As users provide more information to the system about various network destinations the system is able to provide more information to users about more network destinations and thus generate more accurate filter parameter suggestions. After a user selects their filter parameters the system filters a range of information coming from the user and going out to the network destination.

### BACKGROUND OF THE INVENTION

The present invention relates generally to network access privacy and more particularly to the limiting of information migration from a user into a network.

Data networks are becoming increasingly prevalent, and more and more the act of communicating across these data networks is fraught with privacy hazards. To complicate matters, many companies have complex internal data networks. For example many companies' internal data networks are designed to allow for intra-company communications, such as email, documents, voice, video and multimedia. Further, these internal data networks are connected to an external data network (e.g. the Internet) to allow for the exchange of information between the internal and external networks. External network destinations (e.g. websites) are increasingly gathering data about the users that visit them.

The continued growth of data networks has transformed the Internet into a tool for everyday use. Individuals and businesses are increasingly using the internet to conduct business. This growth has also resulted in increased risks, for example, information based fraud, mischief, vandalism, human error, and cyber terrorism. The reality of the risk significantly increases the cost associated with conducting business or communications over the Internet specifically and generally over any type of network.

Firewalls are intended to shield data and resources from the potential danger of network intruders. In essence, a firewall functions as a mechanism which monitors and controls the flow of data between two networks. All communications, e.g. data packets which flow between the networks in either direction must pass through the firewall. Communications that go around the firewall circumvent security which poses a privacy risk to the system. The firewall security permits the communications to pass from one network to the other to provide bidirectional security.

While firewalls work to prevent security breaches and attacks they do not protect privacy or prevent a user's information from being captured. For example, packet sniffing on a network link may comprise a user's private information. The sniffers catalog the user's information and may use it for purposes not known or consented to by the user.

Some products attempt to keep a catalog or list of harmful websites and network destinations in order to prevent their users from being harmed. While this approach appears to be good in theory, in practice it is virtually impossible to catalog every harmful network destination or website. Finally, there are other privacy products that attempt to conceal a user's identity from all network destinations; some examples of these types of products include Privacy Pro and Net Concealer. The deficiency with these total concealment systems is that there are many network destinations that a user would prefer to disclose some level of personal information to. None of the systems discussed have the ability to provide users with protection that varies based on the network destination they are in communication with.

### BRIEF SUMMARY OF THE INVENTION

The present inventors have invented a system of providing network access privacy by limiting a user's personal information from getting to a network. The method involves classifying users based on various attributes and behaviors, generating suggested filter parameters for users, making those suggestions available to the users, and after receiving user input, adjusting the user's filters to limit that user's information from reaching a network. The suggestions that are generated are based on a combination of user attributes, network attributes and the behavior of other users.

Once a set of filter parameters have been adopted by an individual user, the system will filter that user's information according to the settings in the filter. The settings in the filter are based on a series of attributes and data gathered by the system from the individual user as well as other users. These attributes include, but are not limited to, the users' individual risk tolerance, occupation, age, etc., and data collected about network destinations from other users. The range of user information suggested for filtering is dependent upon the perceived hazard posed by the specific network destination.

Information from the entire user group is analyzed by the system in order to generate suggested parameters for new users and to update current users with new information. Thus, as more users provide more information to the system, the system grows and is able to offer more specific information to other users about potential hazards of various networks and network destinations. The accumulation of additional information about a user also allows the classification of the user to change. The accuracy of data regarding various networks and network destinations is also enhanced so that better suggestions regarding filter parameters can be generated.

Lastly, if information has been unknowingly placed on a user's computer, the present invention prevents that information from being unintentionally communicated to others. For example, it is not uncommon for incoming information to be deposited on a computer without the knowledge or consent of the computer user. Information moving across a network such as email could contain other information such as credit cards or social security numbers or other personal information. Regardless of how the information was placed on a user's computer, the invention limits the information from leaving the computer as outgoing information into a network.

### BRIEF DESCRIPTION OF THE DRAWINGS

FIG. 1A shows a system in accordance with one embodiment of the present invention;

FIG. 1B is a block diagram showing further details of the system as depicted in FIG. 1A;

FIG. 1C is a block diagram showing further details of the system as depicted in FIG. 1B;

FIG. 2A is a flowchart showing high-level steps performed by the system in accordance one embodiment of the present invention;

FIG. 2B is a flow chart showing further details of the step of classification performed by the system in accordance with one embodiment of the present invention;

FIG. 2C is a block diagram showing further details of the system in accordance with one embodiment of the present invention;

FIG. 2D is a block diagram showing further details of the system in accordance with one embodiment of the present invention;

FIG. 3 is a diagram showing three examples of the filtering operation of the system in accordance with one embodiment of the present invention; and

FIG. 4 shows a block diagram of a general purpose computer in accordance with one embodiment of the present invention.

### DETAILED DESCRIPTION

The present invention relates to a method and apparatus for providing network access privacy. One embodiment of the invention provides privacy by selectively removing personal information associated with a user and preventing that information from reaching a network destination. This embodiment has a selectivity feature that allows it to determine on a destination by destination basis how much of the user's information is allowed to be communicated to any specific network destination. This feature gives the invention the advantage of being able to provide variable amounts of user information to various network destinations. The ability to provide variable amounts of a user's information is important because it allows a user to quickly and efficiently access network destinations without giving too much information to those network destinations that are unknown or untrustworthy while giving necessary information to those network destinations that are trusted.

On an individual user basis, one embodiment of the invention functions by monitoring the user and analyzing the network destination that the user is attempting to access. The invention analyzes the network destination and compares it in an internal database and then determines based on information in the database and settings in the user profile how much of the user's personal information should be communicated to that specific network destination. It should be noted that the invention simultaneously monitors all users in the system at all times that are in communication with a network. One of the elements of the system is a filter. The user profile settings provide information to the filter that determines how much of the individual user's information is going to be communicated to an individual network destination. The user profile settings for each user of the invention are created based on data which is continuously gathered, updated and analyzed. Some of the data that is used to configure the user's profile is gathered directly from the user, while the rest of the data used to configure the user's profile is gathered from other users that the system is continuously monitoring.

In order to gather the most relevant data for individual user profile settings, users are classified and placed into “user groups”. User groups are groups of users who share some similar attributes. The “data from other users”, as previously mentioned is in fact data taken from the user groups. This is the data used to generate suggested filter parameters. The suggested filter parameters are provided to the user who has not adopted the filter parameters of the user group that they have been classified in.

This feature of one embodiment of the invention is very powerful and offers an advantage over other systems because it automatically provides an individual user with the knowledge and experience of peers who are similarly situated. The invention allows the individual user to avoid the potential risk of exposure by providing this user with the benefit of all of the combined knowledge of the group. As an additional benefit of the invention it should be noted that the combined knowledge of the group will continue to expand and become more specific as more users join the group. This is because the users in the group will adjust their filter settings as they continue to access various network destinations in order to cope with risks and in turn that information will be disseminated among the rest of the users in the group.

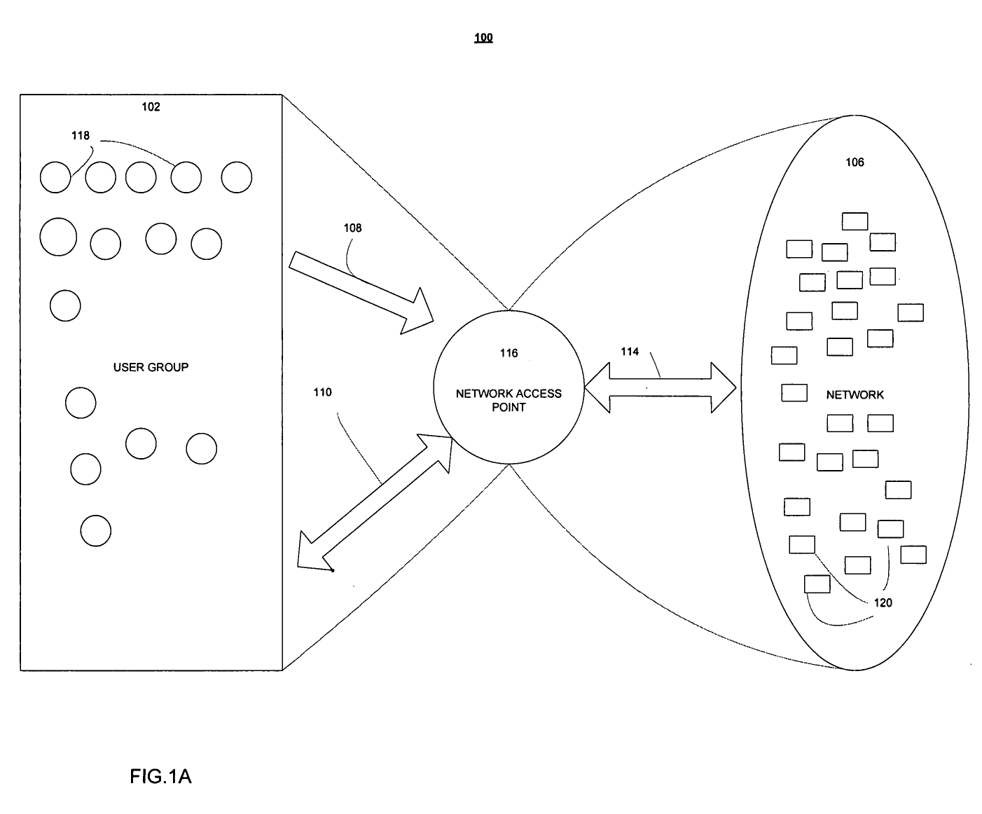

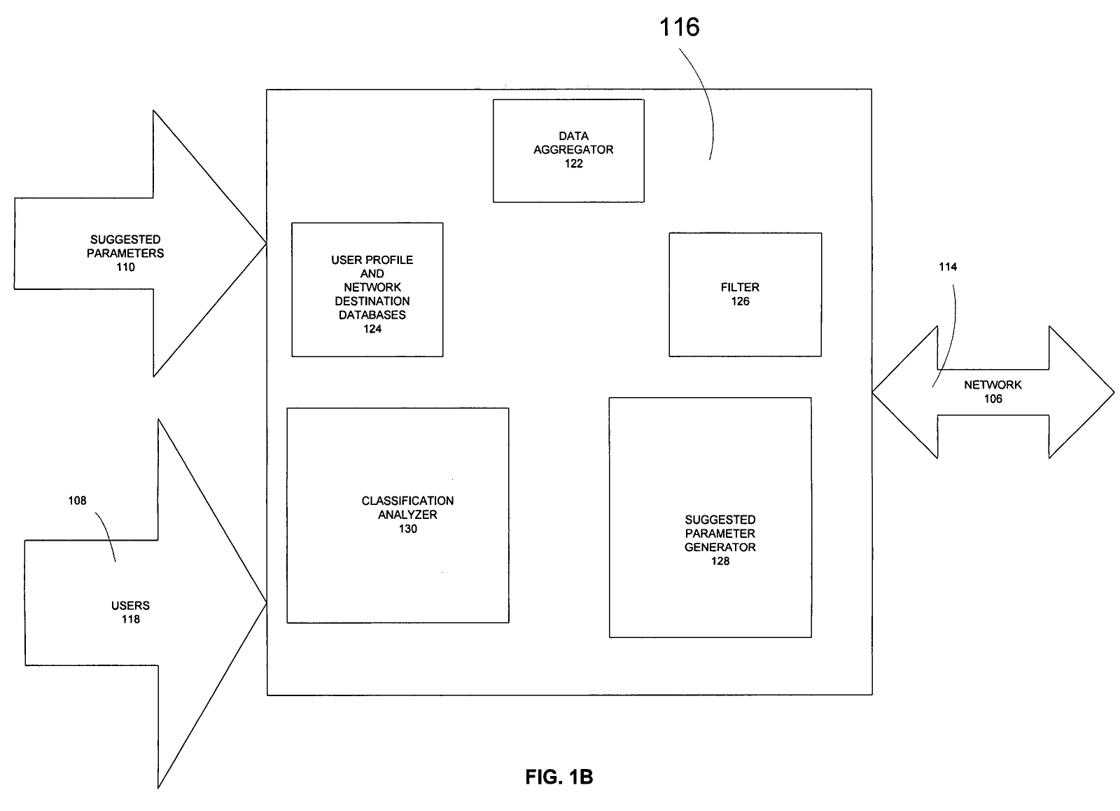

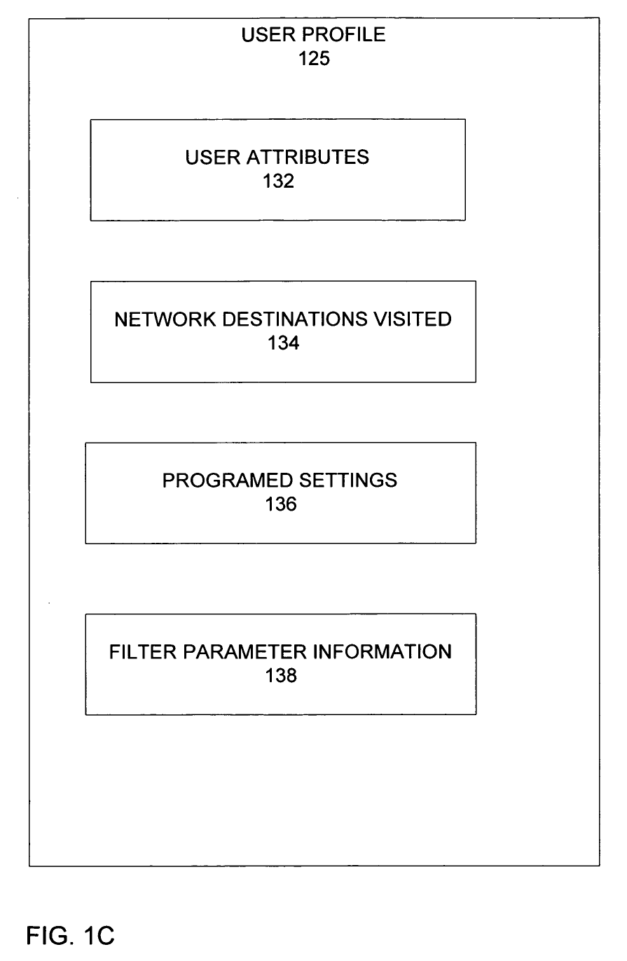

FIGS. 1A and 1B show a system 100 in accordance with one embodiment of the present invention. FIG. 1A shows a user group 102 having users 118 communicating with a network access point 116 and a network 106 having network destinations 120. The user group 102 is comprised of users 118. The term “user” as referred to throughout the specification refers to computers and clients. The users 118 communicate with the network access point 116 as represented by arrows 108 and 110. The network access point 116 allows communication between the network 106 and the users 118 of user group 102 as represented by arrow 114.

FIG. 1B shows the network access point 116 in further detail. In the particular embodiment being described, several elements are shown to be inside the network access point 116. These elements include, but are not limited to, a data aggregator 122, a user profile database and a network destination database 124, a filter 126, a classification analyzer 130, and a suggested parameter generator 128.

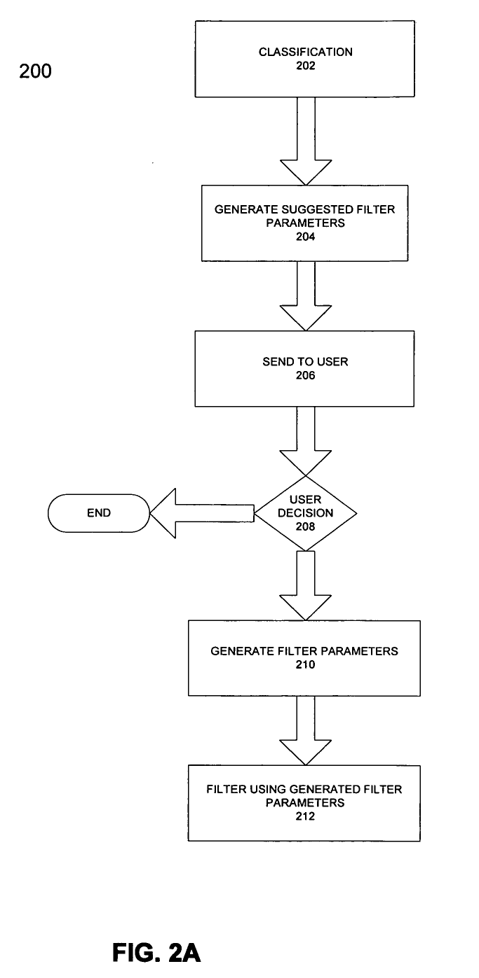

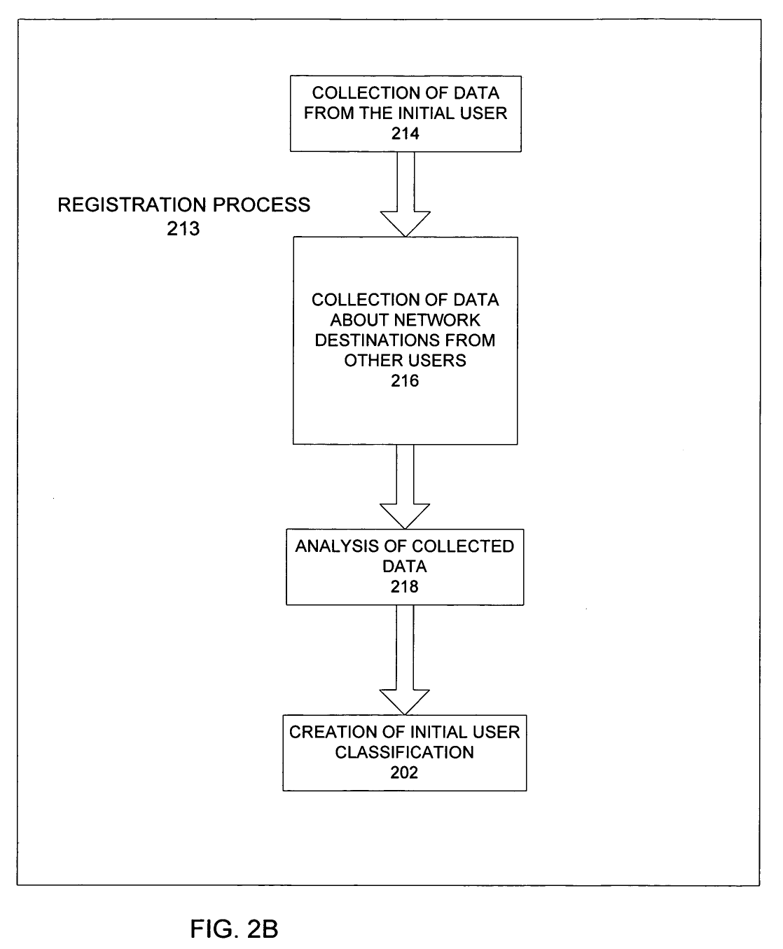

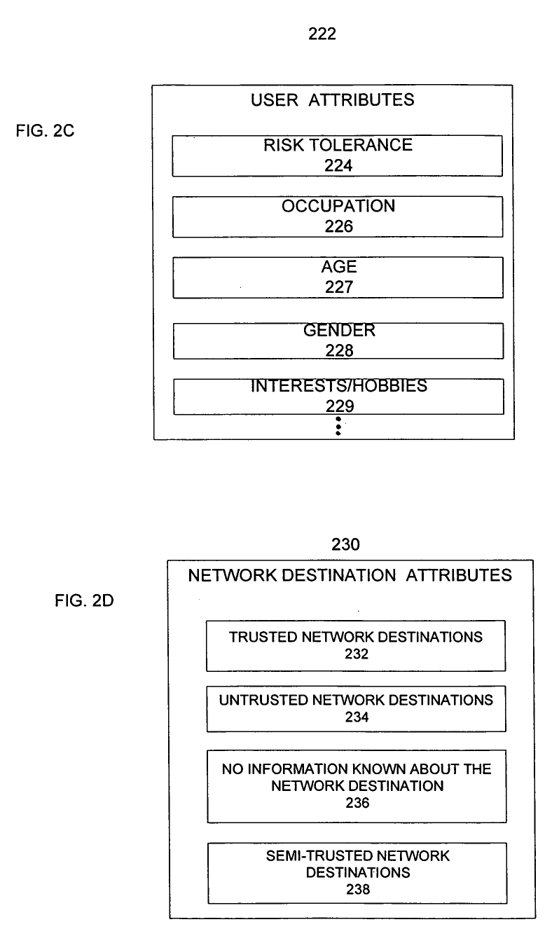

The first element, the data aggregator 122, collects data and aggregates it. The data is collected by monitoring data traffic passing between users 118 and the network 106. Data is collected for every user 118 in the user group 102. The step of data collecting is depicted and further discussed in FIG. 2B step 214. The second element of the network access point 116 is the user profile and network destination database 124. The database 124 stores data about users 118 and information about network destinations 120 that the users 118 have accessed. The database information is used in the methods depicted in FIGS. 2A and 2B. In FIG. 2A a method is shown wherein a set of suggested filter parameters are generated, shown as step 204, these suggestions are stored in the database 124 along with data from the user decision of step 208, and filter parameters from step 210. The information stored from the steps of FIG. 2A is used by the filter 126 of FIG. 1B. The filter 126 filters user information by removing certain user information from the user's data packets as shown in step 212 of FIG. 2A.

The suggested filter parameter generator 128 generates suggestions that are made available to the users 118 about configuring their filters 126. For example, in one embodiment of the invention, the suggestions that are made available to the users 118 are provided in a menu that is prepopulated as a user 118 visits a site. Filter 126 as depicted represents multiple filters. This embodiment of the present invention allows for each user to have at least one filter 126. The suggestions are generated and made available to the users 118, as depicted by arrow 110, while the users 118 are attempting to access various network destinations 120, depicted as arrows 108 and 106 and further shown as step 204 in FIG. 2A. The suggested parameter generator 128 functions by taking the information gathered by the data aggregator 122 and analyzing it in order to generate suggested filter parameters to the users 118. The data used by the suggested filter parameter generator is information that has been stored in the user profile 125, shown in FIG. 1C, and network destination database 124 after it was gathered and aggregated by the data aggregator 122.

The network access point 116 also includes the classification analyzer 130. The classification analyzer 130 analyzes a user 118 in order to provide a classification for that user 118. All users are analyzed and classified at least once. During the registration process 213 (as shown in FIG. 2B) the initial user 118 is classified. The steps of the method of creating the classification for an initial user 118 are the steps 214, 216, 218, and 202 of FIG. 2B, these are discussed more fully below.

In practice, the users 118, as depicted by arrow 108, access the network 106, as depicted by arrow 114, by utilizing the network access point 116. Arrow 110 shows the flow of information back to the users including suggested filter parameters. The suggested filter parameters are generated for the users 118 at the network access point 116 and communicated back to the users 118 of the user group 102 as shown in FIG. 1A.

FIG. 1C shows an example of a user profile 125 that is stored in the user profile and network destination database 124 of FIG. 1B. All of the user profiles 125 of all of the users 118 are stored in the user profile and network destination database 124. Each user 118 has its own user profile 125. The user profile 125 stores specific information about a user 118. Information stored about the user 118 includes, user attributes 132, networks visited 134 by the user 118, programmed settings 136 for that individual user 118, and filter parameter information 138 associated with the user 118.

The first element of the user profile 125 as shown in FIG. 1C is the user attributes 132. The purpose of the user attributes 132 is to store characteristics of a user 118. These attributes 132 are used to classify the user 118 into a specific user groups 102 and provide a user 118 with suggested filter parameters. In practice, the classification analyzer 130 monitors the user attributes 132 of a user 118 and determines, as information is aggregated, whether or not to change the classification of the user 118. Similarly, the suggested filter parameter generator 128 also monitors the user attributes 132 and determines, as additional information is aggregated, whether or not to generate suggestions for the user 118 or other users of the user group 102.

The second element of the user profile 125 is network destinations visited 134. Network destinations visited 134 is a table of all of the network destinations 120 that the user 118 has visited and the filter parameters as set by the user for each of the network destinations 120. This information is used by the suggested filter parameter generator 128 in order to provide statistical information for all of the users 118 of the user group 102. Similarly, the classification analyzer 130 also uses the information regarding the network destinations visited 134 to reclassify users. By placing all of the network destinations 120 that the user 118 has visited in a table with the filter parameters and storing them in a database 134, both the classification analyzer 130 and the suggested parameter generator 128 have an ever growing pool of network destination information that enables the production of better and more accurate information for the users 118 and the user groups 102 on an ongoing basis. Over time the quantity of the destinations recorded (or other information) may become very large. Clean-up may be performed to periodically expunge certain information in order to maintain a reasonable amount of information.

The third element of the user profile 125 is the preprogrammed settings 136. These are standard default settings that are automatically provided for each user by the system 100. These default settings are especially useful to new users 118 who have not been classified or do not have time to respond to system generated queries regarding suggested filter parameters. In one embodiment of the invention, an initial user 118 upon registering with the system 100 is asked to choose from a menu of settings. If the user forgoes this step in the registration process the system will apply a set of preprogrammed or default settings to the user's profile 125. These settings allow a user 118 to start accessing network destinations 120 with a standard level of protection. After an initial user 118 is classified and placed into a user group 102 the system 100 will prompt the user 118 to choose a level of protection, if again, the user 118 chooses to forego this process the system 100 will continue to apply the preprogrammed settings 136 to the user 118.

The last element in the user profile 125 is the filter parameter information 138. The filter parameter information 138 refers to the settings that are applied to the filter 126 for the user 118. Every user 118 has its own user profile 125 and its own individual filter parameter information 138. The filter parameter information 138 allows the filter 126 to prevent certain user information from going into a network 106 and reaching a network destination 120. The amount of user information provided by the filter 126 about the user 118 varies based on the individual network destination 120 accessed.

FIG. 2A is a flowchart showing a set of high-level steps of the method 200 in accordance with one embodiment of the present invention. These steps are performed within the network access point 116 as shown in FIGS. 1A and 1B. The method 200 is performed periodically. The first time the method 200 is performed is during the initial user registration 213, as shown in FIG. 2B, after which, the method 200 is performed each time the user 118 connects to the network 106. It should be noted that when a user 118 joins the system 100 for the first time they are automatically classified as an initial user 118.

When the initial user 118 connects to a network 106 for the first time, the registration process 213 is initiated, as shown in FIG. 2B. During this process, the initial user 118 registers with the system 100 and goes through the steps of classification including collection of data from the initial user 214, collection of data about network destinations from other users 216, analysis of collected data 218, until the step of creation of initial user classification in step 202. After which the user 118 has now become classified as part of the user group 102.

The step of classification 202 is used during the registration process 213 and also occurs independently after the initial user 118 is registered. Once registered, the status of the user 118 is changed from initial user 118 simply to user 118, the system 100 records the change and saves the user's 118 new designation in the user attributes 132 section of the user profile 125 which is located within the user profile and network destination database 124 as previously discussed and depicted by FIGS. 1B and 1C.

After a user 118 has been classified into a user group 102 the user 118 is then classified by its filter parameters. All of the users 118 in the user group 102 are classified by their filter parameters. Classifying the filter parameters of a plurality of users is done periodically for each user group 102. The system 100 continuously gathers information on user's 118 preferences then it periodically compares the settings of each user 118 to that of the entire user group 102. The information gathered from this comparison determines what filter parameters are set by the majority of users 118 of a user group 102. The system 100 then generates suggestions, as noted by step 204 of FIG. 2A. These suggestions on how other similar users are setting their filter parameters are made available to the rest of the users 118 in the user group 102 in step 206. This feature allows users 118 to take advantage of otherwise unknown information regarding the behavior of similar users 118 so that those users 118 may make an informed decision regarding how much of their personal information should be allowed to reach a given network destination 120.

After suggested filter parameters are sent to the user 118 in step 206, the user 118 decides whether or not to follow the system's suggestions 208. After the user 118 makes the decision 208, a response is sent back to the system 100. If the response was yes, to accept the suggested filter parameters, then the system 100 generates new filter parameters for the user 210 and begins filtering using those newly generated filter parameters 212. If the user 118 declines to accept the new filter parameters suggested by the system 100, the method 200 will be terminated and the pre-existing filter parameters for the user 118 will not be changed.

FIG. 2B is a flow chart showing details of the registration process 213 and classification step 202 performed by the system 100 in accordance with one embodiment of the present invention. The registration process 213 is an entire process that includes all of the steps of FIG. 2B and serves two purposes. The first purpose is to register the user with the system and the second purpose is to collect an analyze data in order for the initial user classification to be created in step 202. The relationship between FIGS. 2A and 2B is that they share the classification step 202.

Classification of an initial user 118 in this embodiment involves collecting and analyzing information from a plurality of sources. In order to classify an initial user 118, data from the user 118 is first collected in step 214. This data is comprised of user attributes as depicted in FIG. 2C, these attributes include but are not limited to, risk tolerance 224, occupation 226, age 227, gender 228, and interest/hobbies 229. Each of these attributes is used to classify a user 118 into a specific user group 102. Once a group 102 is created, the filter parameters of the users 118 in the user group 102 are analyzed and compared to each other. An example of a user group could be, “male patent attorney's between the ages of 25 to 55 years old that are risk averse”.

The second step 216 of the registration process 213 is the collection of data about the network from other users. In this embodiment of the invention, data is collected about the network destinations 120 from other users 118 in of the system 100, but it would be understood by one skilled in the art that data could be collected from other sources. FIG. 2D shows a block diagram 230 depicting network destination attributes based on a level trust associated with a specific network destination 120. As an example, four categories of trust serve to classify all network destinations 120. The term “all network destinations” refers to those network destinations 120 that have been accessed by at least one user 118 of the system 100. The categories depicted are, a trusted network 232, an untrusted network 234, a network that it has no information about 236, or lastly, a partially-trusted network 238, i.e. a network that it has mixed information about. Each level of trust associated with a specific network destination 120 is determined by analyzing the behavior of other users 118. How other users 118 set their filter parameters regarding a specific network destination 120 is important information. Data from the filter parameters of each user 118 is analyzed in step 218.

Analyzing the data 218 is the next step of the registration process 213. In this step, the system 100 analyzes all of the information it has gathered in the previous two steps, 214 and 216. During this analysis step 218, the network access point 116 makes certain assumptions about the user 118 in order to fill in gaps in information that it does not have. The network access point 116 makes these assumptions during the analysis step 218 in order to complete the process of creating an initial user classification 202. The initial user classification 202, while based on a significant amount of data as described in the previous steps, is not based on suggested filter parameters.

The network access point 116 allows for the user 118 to be reclassified on an ongoing basis. Reclassification of a user may occur for several different reasons. One reason for reclassification is that the user 118 provides answers to the questions regarding suggested filter parameters that have been generated by the system 100 and communicated to the user 118. These user responses to the queries affect how much of the user's information will be filtered and from which network destinations 120 they are being filtered from. Another reason for a user 118 being reclassified is that the user 118 may change the attributes relating to their profile, the system 100 would analyze these changes and could automatically change the user's classification. Yet another reason for reclassification lies within the individual user 118. The user may manually change their profile preference settings and thus again the system 100 would automatically change the users classification.

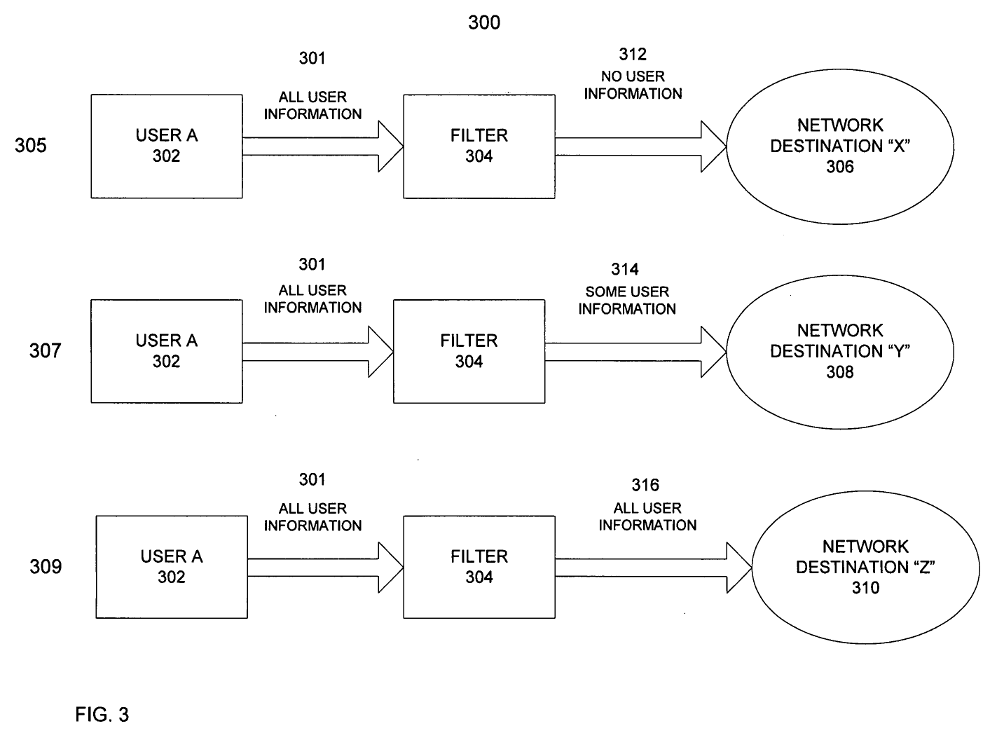

FIG. 3 is a diagram showing three examples of the filtering operation of the system 100 in accordance with one embodiment of the present invention. The filtering parameters used in the filtering operation of FIG. 3 are derived directly from the method 200 and as previously discussed in step 212 of FIG. 2A. Shown as block 302 is user A, a typical user 118 of a user group 102 as previously discussed in FIG. 1A. FIG. 3 shows the user A 302 communicating with three different network destinations on a typical network (e.g., the Internet). In each of the three examples a different level of information is being allowed to pass through the filter 304 to the network destination. Each network destination (“X” “Y” and “Z”) depicted has a different set of user and network attributes which is applied to the filter 304 and thus the filtering for each network destination is different. The filter 304 is the same filter previously discussed in FIG. 1B and in this embodiment of the present invention resides in the network access point (not shown). Methods of limiting a user's information from migrating to a network are well known to those skilled in the art.

In the first example 305, user A 302 elects to communicate with network destination “X” 306. In this example, the system has analyzed network destination “X” 306 and assigned it a network attribute (as previously discussed in FIG. 2D). The system then classified this network destination as “untrusted”. In this example the user's specific attribute regarding risk tolerance is set at “low”, meaning that the user has identified itself as being risk averse. The filter 304 is then adjusted by the system accordingly to prevent certain user information 301 from reaching this network destination 306. As shown by arrow 312, no user information is being communicated to the network destination “X” 306.

In the second example 307, the user A 302 has elected to communicate with network destination “Y” 308. In this example, the system has analyzed network destination “Y” 308 and assigned it a network attribute (as previously discussed in FIG. 2D). The system then classified this network destination as “partially-trusted”. In this example, the user has changed their user specific attribute regarding risk tolerance to “moderate”, meaning that the user has identified itself as being tolerant of some risk. The filter 304 is adjusted by the system accordingly to allow only some user information 314 to reach the network destination “Y” 308. In operation, the arrows show the user information 301, being sent by user A 302 to the filter 304. Some of the information is partially removed by the filter 304 in accordance with principles of the present invention. Only a portion of the original information, as shown by the arrow “some user information” 314, is communicated to the network destination “Y” 308.

In the final example of FIG. 3, user A 302 has elected to communicate with network destination “Z” 310. In this example, the system has analyzed network destination “Z” 310 and assigned it a network attribute (as previously discussed in FIG. 2D). The system then classified the network destination “Z” 310 as a “trusted destination”. In this example the user has set their user specific attribute regarding risk to “high”, meaning that they are willing to accept a higher degree of risk. The system then adjusts the filter 304 accordingly. Thus, all user information 301 flowing into the filter 304 is allowed to be communicated, as seen by arrow 316, to network destination “Z” 310.

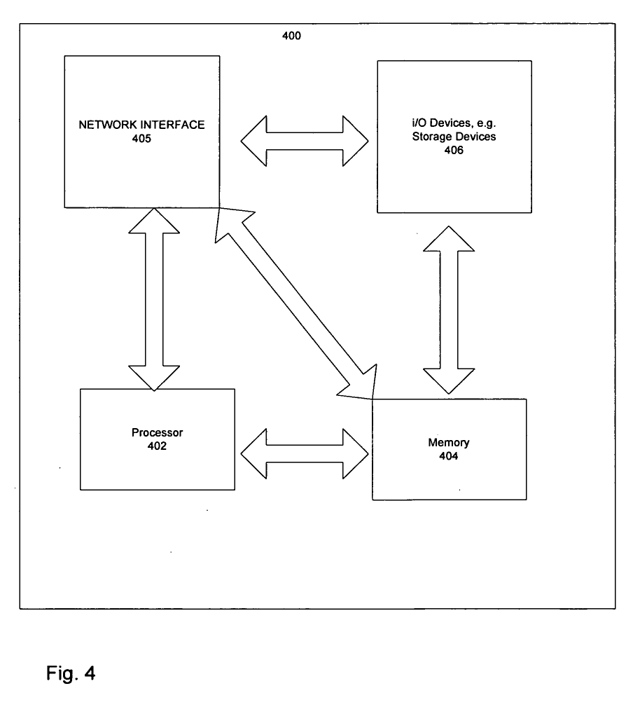

FIG. 4 depicts a high level block diagram of a general purpose computer suitable for use in performing the functions described herein, including the steps shown in the flowcharts of FIGS. 2A and 2B. As depicted in FIG. 4, the system 400 includes a processor element 402 (e.g., a CPU) for controlling the overall function of the system 400. Processor 402 operates in accordance with stored computer program code, which is stored in memory 404. Memory 404 represents any type of computer readable medium and may include, for example, RAM, ROM, optical disk, magnetic disk, or a combination of these media. The processor 402 executes the computer program code in memory 404 in order to control the functioning of the system 400. Processor 402 is also connected to network interface 405, which receives and transmits network data packets. Also included are various input/output devices 406 (e.g., storage devices, including but not limited to, a tape drive, a floppy drive, a hard disk drive or compact disk drive, a receiver, a transmitter, a speaker, a display, a speech synthesizer, an output port, and a user input device (such as a keyboard, a keypad, a mouse and the like)).

Given the present description of the invention, one skilled in the art could readily implement the invention using programmed digital computers. Of course, the actual implementation of a network node in accordance with the invention would also include other components as well. However, for clarity, such other components are not shown in FIG. 4.

It should be noted that the present invention can be implemented in software and /or in a combination of software and hardware, e.g., using application specific integrated circuits (ASIC), a general purpose computer or any other hardware equivalents.

One skilled in the art will recognize that the various embodiments described herein may take different forms. For example, the embodiments described here may be implemented in both hardware and/or software. Additionally, as shown in the above mentioned pictures, the aggregation point and implementation points are shown occurring at the network access point. This is illustrative in nature and is merely included to show various possible embodiments herein. One skilled in the art will recognize in light of the forgoing that a particular implementation or deployment may be chosen. Finally while the above description describes the illustrative embodiment where information gathering and filtering occur, one skilled in the art will also understand that the foregoing may be implemented at any point in the system between a user and a network.

The forgoing detailed description is to be understood as being in every respect illustrative and exemplary, but not restrictive, and the scope of the invention disclosed herein is not to be determined from the detailed description but rather from the claims as interpreted according to the full breadth permitted by the patent laws. It is to be understood that the embodiment shown and described herein are only illustrative of the principals of the present invention. Those skilled in the art could implant various other feature combinations without departing from the scope and sprit of the invention.

1. A method of providing network access privacy comprising the steps of:
classifying filter parameters of a plurality of users accessing a plurality of network destinations;
generating suggested filter parameters for a user based upon said step of classifying.

2. The method of claim 1 wherein the step of generating comprises:
generating said suggested filter parameters based at least in part on attributes of said user.

3. The method of claim 1 wherein the step of generating comprises:
generating said suggested filter parameters based at least in part on attributes of a network destination of said user.

4. The method of claim 1 wherein the step of generating comprises:
generating said suggested filter parameters based at least in part on attributes of said user and attributes of a network destination of said user.

5. The method of claim 1 further comprising the step of:
filtering network communications of said user using said suggested filter parameters.

6. The method of claim 1 wherein the step of classifying comprises:
collecting data from a plurality of users that access at least one network destination.

7. The method of claim 1 wherein the step of classifying comprises:
collecting data from a plurality of network destinations that are accessed by at least one user.

8. The method of claim 1 wherein the step of classifying comprises:
analyzing data collected from at least one user.

9. The method of claim 1 wherein the step of classifying comprises:
analyzing data collected from at least one network destination.

10. The method of claim 1 wherein the step of classifying comprises:
analyzing data collected from at least one network destination and at least one user accessing said network destination.

11. The method of claim 1 wherein the step of classifying comprises:
analyzing attributes of at least one user of the plurality of users and at least one network destination.

12. An apparatus for providing network privacy comprising:
means for classifying filter parameters of a plurality of users accessing a plurality of network destinations;
means for generating suggested filter parameters for a user based upon said step of classifying.

13. The apparatus of claim 12 wherein the means for generating comprises:
means for generating said suggested filter parameters based at least in part on attributes of said user.

14. The apparatus of claim 12 wherein the means for generating comprises:
means for generating said suggested filter parameters based at least in part on attributes of a network destination of said user.

15. The apparatus of claim 12 wherein the means for generating comprises:
means for generating said suggested filter parameters based at least in part on attributes of said user and attributes of a network destination of said user.

16. The apparatus of claim 12 further comprising:
means for filtering network communications of said user using said suggested filter parameters.

17. The apparatus of claim 12 wherein the means for classifying comprises:
means for collecting data from a plurality of users that access at least one network destination.

18. The apparatus of claim 12 wherein the means for classifying comprises:
means for collecting data from a plurality of network destinations that are accessed by at least one user.

19. The apparatus of claim 12 wherein the means for classifying comprises:
means for analyzing data collected from at least one user.

20. The apparatus of claim 12 wherein the means for classifying comprises:
means for analyzing data collected from at least one network destination.

21. The apparatus of claim 12 wherein the means for classifying comprises:
means for analyzing data collected from at least one network destination and at least one user accessing said network destination.

22. The apparatus of claim 12 wherein the means for classifying comprises:
mean for analyzing attributes of at least one user of the plurality of users and at least one network destination.

23. A computer-readable medium having stored thereon a plurality of program instructions, the plurality of program instructions including instructions which, when executed by a processor, cause the processor to perform the steps of a method for enhancing internet privacy and security, comprising:
classifying filter parameters of a plurality of users accessing a plurality of network destinations;
generating suggested filter parameters to a user based upon said step of classifying.
